(19) United States
(12) Patent Application Publication
(10) Pub. No.: US 2006/0273895 A1
(43) Pub. Date: Dec. 7, 2006

(54) Portable communication device alerting apparatus

(75) Inventor: Adam Kollin, Troy, MI (US)

Correspondence Address: YOUNG & BASILE, P.C., 3001 WEST BIG BEAVER ROAD, SUITE 624, TROY, MI, 48084, US

(73) Assignee: RHK Technology, Inc., Troy, MI (US)

(21) Appl. No.: 11/146,746

(22) Filed: Jun. 7, 2005

(51) Int. Cl. G08B 1/08

(52) U.S. Cl. 340/539.17

(57) ABSTRACT

A portable communication device alerting apparatus includes visual and/or audible and/or tactile indicators of the occurrence of remotely located events which are recognized by detectors which transmit a signal to receivers in a communication device base station or directly to a communication device. The receivers recognize the specific detector output and cause the communication device to generate visual, audible and/or tactile indicators identifying the specific detected event occurrence. The indicators on the communication device may include pre-stored audio streams mimicking the occurrence of an audio component of the detected event or the actual sounds of the event. The indicators may also be a sequence of discrete audible tones and/or tactile pulses and/or illuminatable lights on the communication device which alert the user of a detected event occurrence. The receivers can learn the identification of a receiver. The data communication link between each receiver and transmitter may be supervised or unsupervised.

### BACKGROUND

The present invention relates, in general, to remote signaling apparatus.

At home or at work, individuals frequently engage in high sound producing events or are located in areas in which high levels of sound are present, such as while vacuuming, running power tools, or mowing the lawn, such high sound levels can make it difficult for an individual to hear sounds of interest, such as a baby cry, smoke detector activation, telephone or doorbell. In addition to high noise level environments, an individual may simply be outside of the house and thereby too far away from a sound of interest, such as a baby cry, smoke detector activation, telephone or doorbell to hear the sound.

Signaling apparatus have been devised to alert the hearing impaired or others who may have full use of their hearing, but are in a high sound environment, such as while vacuuming, using power tools or a lawn mower, or even listening to an audio receiver at high volume levels, of sound producing events, such as a doorbell or telephone ring, smoke detector alarm, baby's cry, etc. Typically, a lamp or vibrator connected to the signaling system is activated in a coded sequence specific to each remote signaling device. Power line and radio frequency carriers are used to transmit activation signals from the remote detectors to a base station which then detects which sensor or detector has been activated and then sends the appropriate signaling sequence to a receiver connected to a lamp or portable vibrator. Other signaling apparatus systems send the signals directly from each sensor to a remote lamp or vibrator signaler coupled to the lamp or vibrator or flash a light or activate a vibrator from the same unit that contains the sensor.

While these types of signaling apparatus are somewhat effective, they require plug-in receivers for each lamp and/vibrator. This type of signaling apparatus also requires that the person be in visual range of the lamp or vibrator to detect its activation. This limits the mobility of the individual and may require additional receivers for lamps or vibrators in many rooms of a house or building so that all detected events can be recognized regardless of where the individual is in the home or building. In addition, existing signaling systems require the use of separate wireless portable telephones, baby monitors, and doorbell signalers making them inconvenient and costly to use.

Wireless portable telephone systems have been devised using 900 MHz and higher carrier frequencies between a base station connected to a building telephone line and a portable or wireless telephone. Such wireless Rf telephone systems enable a user to carry the portable handset a considerable distance away from a base station connected to the house or building telephone line. This enables an individual to hear and answer an incoming telephone call when outside the house. However, even wireless portable telephones may not be effective in high sound level environments.

Rf data links in general fall into the category of supervised and unsupervised. An unsupervised Rf data link means that when one part of an Rf-linked system sends out a signal, it has no way of knowing if that signal was received by the appropriate receiving device. This is the typical method used in a non-critical application such as a garage door opener. If after you press the door opener button on the transmitter the garage door does not open, you simply can keep pressing the button until the door opens. However, for critical applications, such as a remote smoke detector sending a signal to a control panel, it is critical that the Rf link be completely reliable. If a smoke detector were to send a signal to its control panel and the signal were to somehow not be received by the control panel, the result could be the loss of property or life. There are many reasons that an Rf signal might not reach the intended receiver. It could be a malfunction of either the transmitter or receiver, the signal path between the two could be blocked by a metal or other object, the transmitter battery could be low or dead, or a variety of other reasons any of these reasons results in a missed signal which can be critical in certain situations.

It would be desirable to provide a alerting apparatus which addresses all of the problems of prior signaling devices. It would also be desirable to provide an alerting apparatus which detects the occurrence of a plurality of remotely located sound generating events and which transmits a signal to a portable telephone to alert an individual of the specific detected event.

### SUMMARY

An alerting apparatus includes means for detecting the occurrence of at least one event, which may or may not have an audio component or be associated with an audible sound producing event, means, responsive to the detecting means, for wirelessly transmitting a signal upon detection of the event occurrence, means for receiving the transmitted signal, and communication means, capable of receiving and transmitting telephone messages using wireless communication and responsive to the receiving means, for generating a recognizable indication of the occurrence of the detected event at the location of the communication means.

In one aspect, the communication means is a portable communication means, such as a portable wireless telephone or portable cellular phone.

In one aspect, the receiver means may be carried in the communication means or provided as one or more first receivers in a base station wherein the base station is part of a wireless portable communication telephone system, or separate receivers carried by the communication means.

The recognizable indication generated by the communication means may be at least one of a visual indicator and an audible indicator. The visual and audible indicators may be illuminatable devices carried on the communication means in the form of one or more discrete lights, an alphanumeric display carried on the communication means, a series of ring tones or tactile vibrations generated by the communication means identifying each discrete event, pre-stored audible messages generated through a speaker on the communication means identifying each event, the generation of audible tones mimicking the sounds of the audio component of the detected event, or the actual sounds associated with the event.

The present alerting apparatus uniquely provides distinct signals or indicators of remotely occurring events on a portable communication device, such as a telephone, to enable the user of the telephone to be located anywhere within a predetermined distance from the remote detectors or an intermediate telephone base station. This eliminates the need to provide signal receivers in many rooms of a building to generate a flashing code associated with the detected occurrence event. In addition, the present alerting apparatus provides an indication of the occurrence of numerous remote distinct events, each of which may have a distinct audio component upon occurrence of event, at a single location, such as in a portable communications device, such as a portable wireless telephone or portable cellular telephone. This eliminates the need for multiple receivers for numerous lamps and vibrating devices disposed without a home or building or carried by an individual to detect a number of different, remote sound producing events.

### BRIEF DESCRIPTION OF THE DRAWING

The various features, advantages and other uses of the present invention will become more apparent by referring to the following detailed description and drawing in which:

FIG. 1 is a block diagram of a signaling apparatus according to one aspect of the present invention; and

FIG. 2 is an enlarged pictorial representation of the portable telephone shown in FIG. 1.

### DETAILED DESCRIPTION

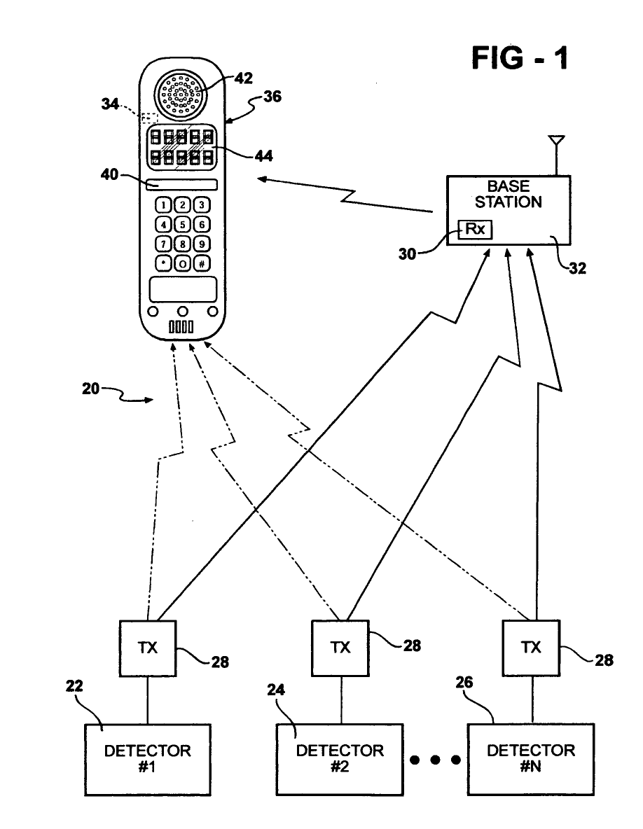

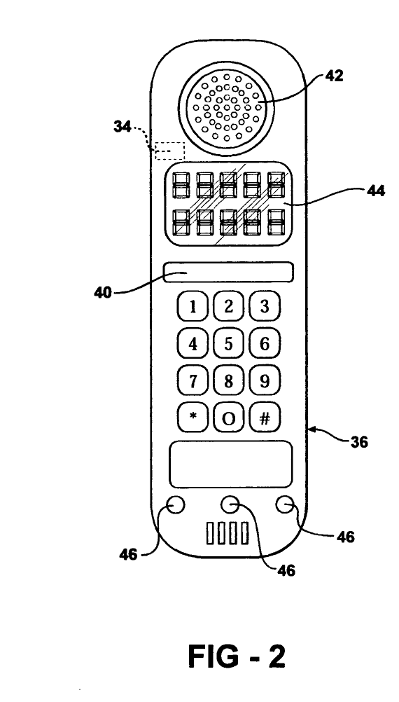

Referring now to FIGS. 1 and 2, there is depicted a signaling apparatus 20 which uniquely provides visual and/or audible and/or tactile indicators of the occurrence of remotely located events, which may or may not have an audible component or be associated with an audible operating event, to a portable communication device which can be easily carried by an individual. The portable communication device may be a portable telephone, cell phone, pda, etc., operating through wireless communication.

The signaling apparatus 20 includes one or more event detectors, with three event detectors 22, 24 and 26 being illustrated by way of example only.

The event detectors 22, 24 and 26 are discrete devices or circuits located within the audible range of an audible sound producing event or device, such as a doorbell, a baby's cry or noise, the audible alarm of a smoke detector, etc., or are circuits or detectors which sense an electrical signal or current generated by a push button closure, a contact closure, a telephone ring signal, a motion detection output, a burglar alarm contact output or any magnetic or thermal sensor output.

Each of the detectors 22, 24 and 26 may include a microphone and filters which receive audio signals, filter out noise or spurious signals so that only a signal frequency range associated with a particular event, such as a doorbell ring, smoke detector alarm, baby's voice, etc., is detected by each of the detectors 22, 24 and 26.

In the case of a doorbell, the detector 22 can alternately be configured to be responsive to an electrical signal generated by the depression of the doorbell pushbutton.

In the case of a smoke detector or door bell, the detector can be hardwired internally to the smoke detector or door bell and not be sound activated, but activated by an electrical or magnetic signal generated by the detector or doorbell when activated.

Once an event occurrence is detected by one of the detectors 22, 24 and 26, an output signal is generated through a radio frequency transmitter 28 coupled to each detector 22, 24 and 26. The radio frequency transmitter 28 provides a radio frequency signal with address or coded data bits identifying the particular detector 22, 24 and 26 associated with the transmitted signal from the transmitter 28. The signals transmitted from each of the transmitters 28 will be received by appropriate receivers within a specified range, such as 100-500 feet, for example only.

It will be noted that the signals transmitted from each of the transmitters 28 may be a coded signal containing one or more data bits identifying the specific detector 22, 24 or 26 which detected an event occurrence and, optionally, additional information such as sound intensity, sound duration, low battery power, heartbeat, or other data, for example. Alternately, the signals transmitted by each of the transmitters 28 may be the actual sound or audio component detected by each detector 22, 24 and 26 or a prerecorded, stored sound simulating the sound or audio component produced by each event, such as a doorbell ring, a baby's cry, a smoke detector alarm, etc. The actual or simulated audio component signals are transmitted by the transmitters 28 to the receiver(s) 30 in the telephone base station 32.

Further, the transmitted signal may be in analog or digital form, be coded or uncoded, or otherwise provided in a form to discriminate between each detector 22, 24, and 26.

In one aspect, a radio frequency receiver(s) 30 is mounted in a wireless telephone base station 32 which receives and decodes the transmitted signals to identify the particular detector 22, 24 and 26 which has detected the occurrence of an event.

Alternately, receivers 34 may be provided in a portable telephone 36 for detecting, decoding or otherwise recognizing the same coded signals or simulated or actual sounds from the transmitters 28.

In the case of the telephone base station 32, the base station 32 and portable, wireless telephone 36 may be a wireless telephone system operating with 900 MHz, 2.4 GHz, 5.8 GHz or other carrier frequencies. Upon receiving a signal from one of the transmitters 28, the receiver(s) 30 modulate the signal, either the actual or simulated sound and/or the analog or digital information signal, onto the carrier frequency which is then transmitted from the base station 32 to the telephone 36.

In applications where the telephone base station 32 is not used, the transmitted signals are received by the receiver 34 in the telephone 36 which decodes the signals as described hereafter.

Regardless of the manner in which the transmitted signals associated with an event occurrence are received by the telephone 36, the signals are decoded or otherwise recognized and appropriate output indicators activated on the telephone 36 to provide the user of the telephone 36 with an audible and/or visual and/or tactile indication of the occurrence of one or more detected events.

The indicators on the telephone 36 may, in one aspect, be ring tones or a vibration sequence which can be programmed for each specific event which can be detected by the detectors 22, 24 and 26. Thus, the ring tone and/or the vibration sequence may provide distinct long and short ring or pulse vibration sequence which the user can interpret to identify the particular detected event occurrence.

In another aspect, the output indicator may be a flashing light 40 mounted on the telephone 36. The light 40 may be an LED or a high intensity strobe light which can be used by itself and flashed in a coded sequence to indicate a particular detected event or merely activated in a pulsed on and off sequence to alert the user to look at the telephone 36 for other output indicators.

A tactile indicator such as a vibrator disposed in the telephone 36 could operate the same way as the strobe 40 when the transmitted signals from the detectors 22, 24 and 26 are in the form of coded signals unique for each detector 22, 24 and 26.

Pre-stored audio messages or sound sequences corresponding to each event detected by the detectors 22, 24 and 26 may be stored in a memory in the telephone 36 or in the telephone base station 32 and output through a telephone speaker 42 to mimic a doorbell ring, a baby's cry or a smoke detector alarm. Alternately, the speaker 42 can output the actual or simulated sounds transmitted by the transmitters 28 associated with the detectors 22, 24 and 26.

In another aspect, the output indicators may be alpha-numeric messages provided on a telephone display 44 and/or on the base station 32. After decoding of the received signals by the receiver(s) 34 in the telephone 36 or base station 32, the particular signal associated with one of the detectors 22, 24 and 26 is used by a processor or circuit in the telephone 36 or base station 32 to access a list of pre-stored messages which can identify the particular device or detector, such as a doorbell, including either front or rear doors, a baby noise or cry, a smoke detector activation, alarm clock ring, etc.

In another aspect, the output indicators may be individual illuminatable devices, such as lights or LEDs 46, which are mounted on the telephone 36. Each individual illuminatable device 46 maybe associated with a label identifying one particular detector 22, 24 and 26, or illuminatable in a different color to identify the activated detector 22, 24 and 26.

According to another aspect of the present invention, the telephone 36 may include ambient noise and/or light compensation. The ambient sound compensation detects the ambient or background noise level around the telephone 36 when an incoming detection signal is received. The volume or output of the speaker 42 is adjusted to be louder or softer to enable the user to easily hear a audible event indicator message or sound sequence from the speaker 42.

Similar compensation is provided for applications using the indicator lights 46, the strobe light 40 or the display 44. The ambient light intensity surrounding the telephone 36 is detected when an incoming detection signal is received by the receiver(s) 34 in the telephone 36, and the intensity of the lights 40, or the display 44 are adjusted to be brighter or dimmer to provide a easily recognizable signal.

The digital Rf-linked transmitters and receivers must be matched to each other to enable the receiver to only respond to the desired transmitter and to filter out unwanted transmissions. The matching can be done by the manufacturer or may be set by the customer through dip switches or other settable means in the transmitters and receivers.

Another matching approach, by way of example, uses a “learn” mode of matching the transmitter to the receiver. In this system, each transmitter in the system would be pre-programmed during manufacture with a set of unique numbers that would identify the transmitter to any receiver that is programmed to accept its transmission. The unique numbers could contain a subset of numbers that would identify the model number of the product and a subset of numbers that would identify the serial number of the product. Further subsets of numbers could be programmed to further identify additional features or capabilities of the transmitter.

To program a receiver to “learn” the identity of an accepted transmitter, the user presses a button (or bridges two pins) and the receiver's microcontroller goes into the “learn” mode. While in this mode the receiver is looking for a correctly formatted packet that matches its native data structure. When the receiver sees one of these packets it decodes it and removes the fields of interest, such as model and serial number fields, and adds it to a stored list of known units. Learn mode then terminates and normal operation resumes. After that the receiver will only respond to packets with serial numbers that are in the learned table list.

The stored learned table may contain a method of clearing the stored table, such as pressing and holding the “learn” button, or a separate clear button, for a period of time, such as five (5) seconds.

The data communication between any of the transmitters 22, 24, and 26 and the associated receiver can be supervised or unsupervised. In unsupervised data communication, each of the transmitters 22, 24, and 26 will transmit a detected signal to the associated receiver immediately upon generation of the detection signal. No further circuitry or data processing takes place to determine if the transmitted signal reaches the appropriate receiver. Nor is there any communication between the receiver and the associated transmitter to determine that the transmitter is in an operative state. The detectors 22, 24, and 26 monitor different applications, some of which require continuous communication, such as a baby monitor, and others have more intermittent operation, such as a door bell, telephone ring, etc. Certain other applications are more critical, such as a smoke detector which necessitate an active communication link in order to receive an emergency signal from the smoke detector at any time.

For critical applications, such as a smoke detector, baby cry monitor, etc., supervised data communication may be employed. There are two main types of supervised links: duplex and simplex. In a typical duplex application, the receiver sends out a periodic Rf transmission to query each transmitter's status. Upon receipt of this transmission, each transmitter then sends a reply message to the receiver. This reply message could contain only the ID of the transmitter or other data, such as battery strength. If the receiver receives the reply transmission from a transmitter, it can assume that transmitter has a reliable Rf link. The more often this duplex transmission takes place, the greater the reliability of the system.

In a simplex type of supervision, each transmitter sends out a “heart-beat” signal at predetermined intervals to the receiver. If the heartbeat signal from any transmitter is not received by the receiver within the predetermined interval, the receiver is alerted to the break in the Rf link.

There are advantages to each type of system. The simplex system is less costly as each transmitter does not also need to include a receiver for the query signal from the receiver. This is advantageous in a battery powered device as a transmitter only typically uses less power than a combination transmitter/receiver. The advantage of a duplex system is that the receiver can vary the period between queries depending on conditions. Also, some duplex systems can relay the query signal from transmitter to transmitter, allowing larger systems to be constructed.

Thus, the transmitters with detectors 22, 24, and 26 and the associated receivers may employ either duplex or simplex supervised Rf communication links. In the case where the return message from the transmitter contains additional data, such as a transmitter's battery strength or Rf signal strength, the receiver can retransmit a signal to the portable communication device, in the case of a base station, or directly generate on the personal communication device a signal strength indication on the display of the portable communication device. The signal strength display can be any display in common use on cellular phones, for example only.

The present alerting apparatus uniquely enables detected events remote from the user of a portable communication device or telephone to recognize the occurrence of the detected event via indicators generated by the communication device. This alerting apparatus eliminates the need for connecting receivers to lamp or vibrator devices in a building to indicate that occurrence of a remote event. The user may, thus move freely within a large area with respect to the remote event detectors while still being able to recognize the occurrence of any event which may or may not have an audible component associated with the event occurrence. The present alerting apparatus combines and provides indications of the occurrence of many different events on a single device, such as the communication or portable telephone. This eliminates the need for separate receivers and indicators for each different event, such as a baby monitor, doorbell signaler, smoke alarm signaler, telephone, etc.

What is claimed is:

1. An alerting apparatus comprising:
means for detecting the occurrence of at least one event;
means, responsive to the detecting means, for wirelessly transmitting a signal upon detection of the event occurrence;
means for receiving the transmitted signal; and
communication means, capable of receiving and transmitting telephone messages using wireless communication and responsive to the receiving means, for generating a recognizable indication of the occurrence of the event.

2. The alerting apparatus of claim 1 wherein the communication means comprises a portable communication means.

3. The alerting apparatus of claim 1 wherein the communication means comprises a portable telephone.

4. The alerting apparatus of claim 1 wherein:
the receiving means is coupled to the communication means.

5. The alerting apparatus of claim 1 wherein the communication means comprises:
a base station including the receiving means, the base station including means for wirelessly transmitting a signal associated with the received signal associated with an event occurrence to the communication means.

6. The alerting apparatus of claim 5 wherein the communication means comprises a telephone.

7. The alerting apparatus of claim 1 wherein the communication means further comprises:
means for generating the recognizable indication of the occurrence of an event in at least one of a visual, a tactile, and an audible indicator.

8. The alerting apparatus of claim 7 wherein the indicator comprises:
visual means, carried on the communication means, for visually indicating the occurrence of an event.

9. The alerting apparatus of claim 8 wherein the visual means is a light producing illumination means.

10. The alerting apparatus of claim 9 wherein the illumination means comprises a flashable strobe light.

11. The alerting apparatus of claim 9 wherein the illumination means comprises:
a discrete light generating means associated with each discrete detecting means.

12. The alerting apparatus of claim 8 wherein the visual means comprises:
an alphanumeric display carried on the communication means, the display generating pre-stored messages identifying the specific detecting means which detected an event occurrence.

13. The alerting apparatus of claim 7 wherein the audible indicator comprises:
a unique sequence of ring tones generated and audibly output by the communication means.

14. The alerting apparatus of claim 7 wherein the audible indicator comprises:
at least one pre-stored audible message identifying one detecting means.

15. The alerting apparatus of claim 7 wherein the audible indicator comprises:
audible tones mimicking an audio component of the discrete event detected by each detecting means.

16. The alerting apparatus of claim 7 further comprising:
the transmitting means and the receiving means capable of transmitting and receiving actual audio signals generated by the at least one event; and
the communication means, responsive to the receiving means, for generating an audible signal corresponding to the audio component of the at least one event.

17. The alerting apparatus of claim 1 wherein the communication means further comprises:
means for generating a recognizable tactile indication of the occurrence of an event.

18. The alerting apparatus of claim 17 wherein:
the tactile pulses are vibrations detectable by a user carrying the communication means.

19. The alerting apparatus of claim 1 wherein:
the detecting means includes means for detecting an audible sound associated with the occurrence of the at least one event.

20. The alerting apparatus of claim 1 further including:
means for providing a supervised data communication link between one transmitting means and one receiving means.

21. The alerting apparatus of claim 1 wherein the transmitting means further includes:
means for learning a transmitter ID so that only a signal from one transmitting means is accepted by one receiving means.
